(19) United States
(12) Patent Application Publication
(10) Pub. No.: US 2018/0347677 A1
(43) Pub. Date: Dec. 6, 2018

(54) GEAR RACK TRAVEL STOP AND METHOD OF MAKING AND USING SAME

(71) Applicant: LIPPERT COMPONENTS, INC., Elkhart, IN (US)

(72) Inventors: Brian Carlson, South Bend, IN (US); John Cooreman, Laporte, IN (US)

(21) Appl. No.: 15/995,347

(22) Filed: Jun. 1, 2018

Related U.S. Application Data
(60) Provisional application No. 62/513,779, filed on Jun. 1, 2017.

(51) Int. Cl. F16H 19/04; F16H 55/26

(52) U.S. Cl. CPC F16H 19/04; F16H 2019/046; F16H 55/26

(57) ABSTRACT

A curable adhesive applied between teeth of a gear rack forms a gear rack travel stop. The curable adhesive is applied between teeth of the gear rack in fluid form and cured to a solid form.

### CROSS-REFERENCE TO RELATED APPLICATION

This application claims benefit under 35 U.S.C. § 119 of U.S. Provisional Patent Application No. 62/513,779, filed on Jun. 1, 2017, and incorporates by reference the disclosure thereof in its entirety.

### BACKGROUND AND SUMMARY OF THE DISCLOSURE

It is known in the art to provide a vehicle, for example, a recreational vehicle (RV) or trailer, with a slide-out room that may be reciprocated between an extended position and a retracted position through an opening in a wall of the vehicle. It also is known to provide an operating mechanism to facilitate extension and retraction of the slide-out room.

Some such mechanisms include a rack and pinion gear system having a gear rack attached to a side wall of the slide-out room and a pinion gear attached to the vehicle. The gear rack includes a plurality of evenly spaced-apart, parallel teeth defining valleys therebetween. The pinion gear similarly includes a plurality of evenly spaced-apart, parallel teeth defining valleys therebetween. The system is configured so that the teeth of the gear rack mesh with the valleys of the pinion gear and vice versa so that rotation of the pinion gear yields linear movement of the gear rack, and vice versa.

Such a gear rack typically is toothed from one end thereof to the other. As such, the pinion gear could readily overdrive the gear rack so as to cause the gear rack to become disengaged from the pinion gear. Accordingly, some form of travel stop may be provided to prevent the pinion gear from overdriving and disengaging the gear rack.

A slide-out room typically includes an inner flange extending laterally (or peripherally) outwardly from the slide-out room near the inner end thereof and an outer flange extending laterally (or peripherally) outwardly from the slide-out room near the outer end thereof. When the slide-out room reaches the end of its desired travel in the extend direction, the inner flange engages with the inner surface of the sidewall of the vehicle and precludes further motion of the slide-out room and consequent disengagement of the gear rack from the pinion gear. Similarly, when slide-out room reaches the end of its desired travel in the retract direction, the outer flange engages with the outer surface of the sidewall of the vehicle and precludes further motion of the slide-out room and consequent disengagement of the gear rack from the pinion gear. As such, the inner and outer flanges function as travel stops.

The inner flange, however, typically is not attached to the slide-out room until the slide-out room has been installed in and connected to the vehicle. As such, there is a possibility during the slide-out room installation process, before the inner flange is attached to the slide-out room, that the gear rack may be overdriven by the pinion gear when the slide-out room is extended. As such, the gear rack could become disengaged from the pinion gear, thereby rendering the operating mechanism inoperable until action is taken to reengage the gear rack with the pinion. In a worst-case scenario, the slide-out room could be driven completely out of the vehicle and could fall to the ground.

### BRIEF DESCRIPTION OF THE DRAWINGS

FIG. 1 is a perspective view of illustrative first and second gear racks configured as they might be when attached to a side wall of a slide out room;

FIG. 2 is a perspective view of the first and second gear racks of FIG. 1 and a manifold system for injecting uncured curable adhesive into the valleys;

FIG. 3 is a top plan view of the gear racks and manifold system of FIG. 2; and

FIG. 4 is a top plan detail view of one of the gear racks of FIG. 1 with curable adhesive injected into one of the valleys.

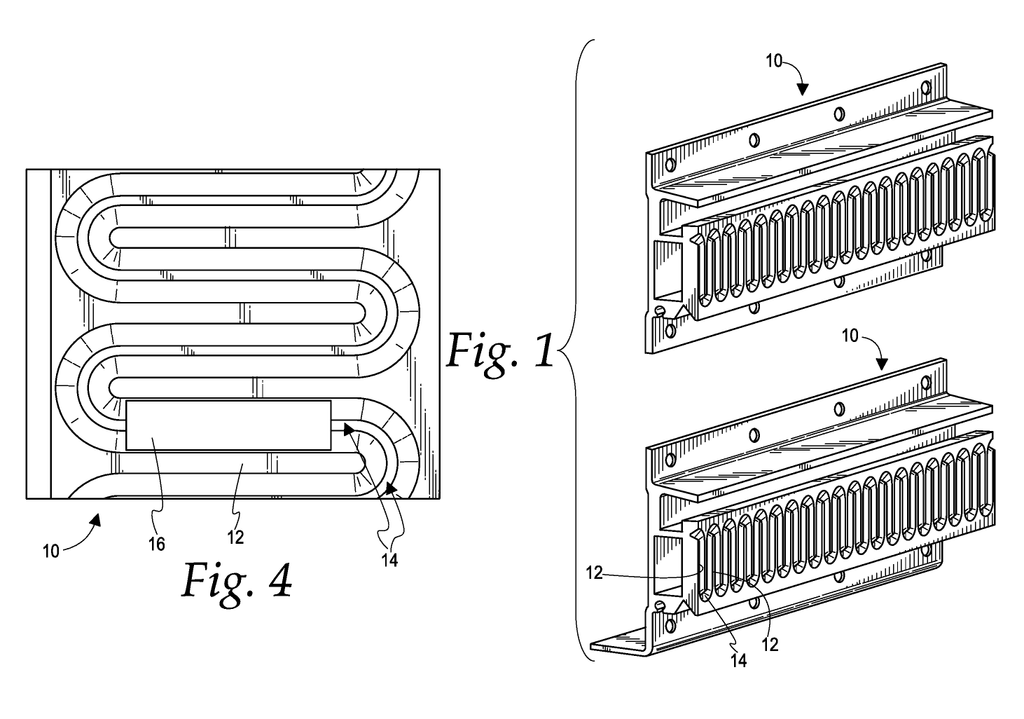

### DETAILED DESCRIPTION OF THE DRAWINGS

The drawings show illustrative gear racks 10 and an illustrative manifold system 100, as will be discussed further below.

Each of the gear racks 10 includes a plurality of evenly spaced-apart, parallel teeth 12. Adjacent pairs of the teeth 12 cooperate to define corresponding valleys 14 therebetween. The gear racks 10 are configured to cooperate (or mesh) with a corresponding pinion gears (not shown) or the like in toothed engagement therewith. More specifically, the teeth 12 of the gear racks 10 are configured to engage with corresponding valleys of the pinion gear, and the valleys 14 of the gear rack are configured to engage with corresponding teeth of the pinion gears (not shown), as would be understood by one skilled in the art.

As best shown in FIG. 4, a mechanical travel stop 16 may be disposed in a respective valley 14 of either or both of the gear racks 10 and self-bonded thereto. The travel stop 16 may be formed by disposing an uncured, curable adhesive into the respective valley 14 and then curing the curable adhesive. More specifically, the valley 14 may first be cleaned by wiping with a suitable solvent, for example isopropyl alcohol. The uncured adhesive may be applied to the valley 14 as a bead. The bead may completely fill the valley. In an embodiment, the bead may extend above the valley and the face of the gear rack in the form of a dome. The dome may be 1/16″ or more or less above the face of the gear rack. In an embodiment, the bead of uncured adhesive may have another profile. The bead profile is selected so that a pinion gear driven into the travel stop, as discussed further below, does not compress or deform the travel stop to an extent that enables the pinion gear to be driven through and beyond the travel stop. The bead of adhesive may then be cured, thereby forming the travel stop 16.

In an embodiment, the curable adhesive may be an adhesive curable by exposure to ultraviolet light (sometimes referred to herein as an ultraviolet light curable adhesive or a UV curable adhesive). For example, the curable adhesive may be LOCTITE® 3972 or LOCTITE® 3979 UV curable adhesive. In such an embodiment, the adhesive may be cured by applying 405 nm (nanometer) ultraviolet light using a LOCTITE® model 7700 hand held LED light source for 10 s at a distance of 1 cm from the bead of adhesive.

In an embodiment, other curable adhesives may be used, and they may be cured in other ways. The curable adhesive may be, but need not be, a UV curable adhesive. In an embodiment, the curable adhesive may have a Shore D hardness of about 56-68 or a greater or lesser hardness when cured. The bead profile, as discussed above, may be selected as a function of the hardness of the cured, curable adhesive, and vice versa, to yield a travel stop that does not compress or deform when engaged by a pinion gear driven thereinto to an extent that enables the pinion gear to be driven through the travel stop and beyond.

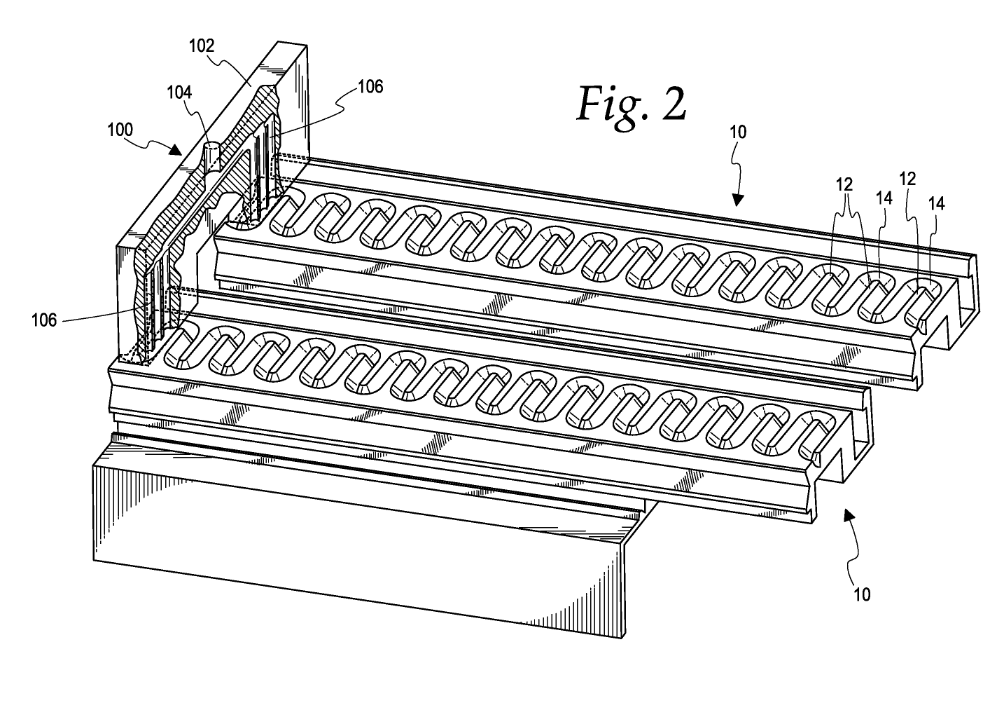

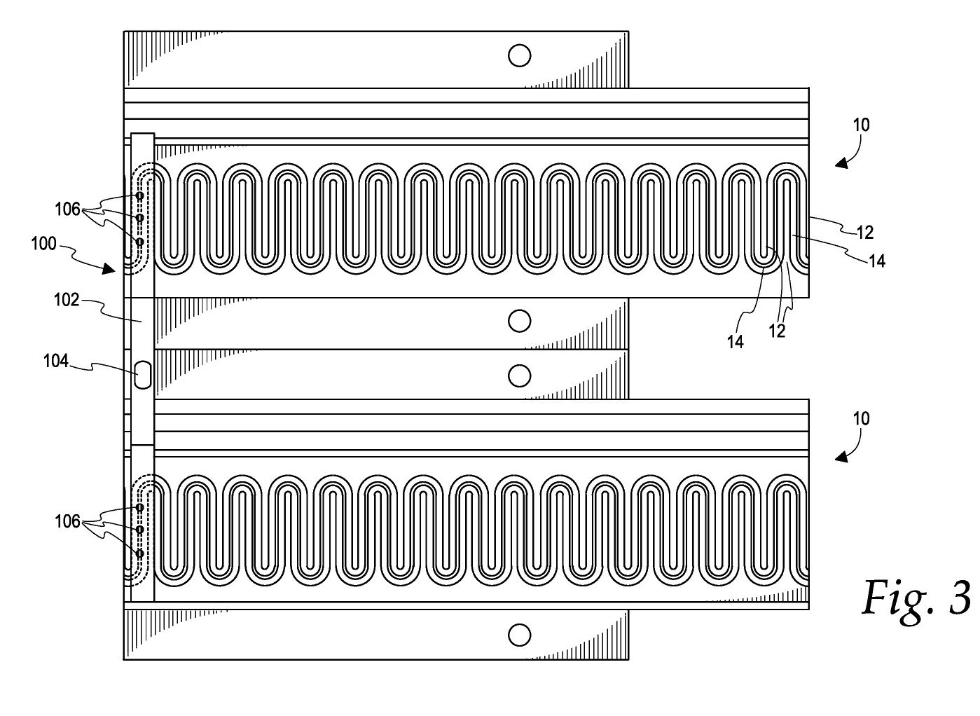

FIGS. 2 and 3 also show an illustrative embodiment of a portion of a manifold system 100 that may be used to apply the uncured, curable adhesive to one or more selected valleys 14 of two gear racks 10. As shown, the manifold system 100 includes a manifold 102 having a feed port 104 for receiving the uncured, curable adhesive from a suitable source and one or more nozzles 106 for dispensing the uncured, curable adhesive to one or more selected valleys 14 of the gear racks 10. As shown, the manifold 102 is configured to apply the uncured, curable adhesive to the valleys 14 of two gear racks 10 at a time, through three nozzles 106 per valley. In other embodiments, the manifold 102 could be configured to receive more or fewer than two gear racks 10 at a time and to apply the uncured, curable adhesive to selected valleys 14 of more or fewer than two gear racks 10 at a time using more or fewer than three nozzles 106 per valley.

Again, as shown, the manifold system 100 is configured to receive two gear racks 10 at a time. A respective end of either or both of the gear racks 10 could engage a corresponding (electromechanical or other) switch to initiate an adhesive dispense cycle. The uncured, curable adhesive may be dispensed from the manifold system 100 to dispose a bead of the uncured, curable adhesive into one or more selected valleys 14 at the end of each gear rack 10, for example, as discussed above.

In embodiments using UV curable adhesive, the gear racks 10 may then be transferred to a curing machine (not shown) configured to expose the uncured, curable adhesive to UV light, for example, as discussed above. Such a curing machine could be configured to receive two gear racks 10 at a time. A respective end of either or both of the gear racks 10 could engage a corresponding (electromechanical or other) switch in the curing machine to initiate a UV curing cycle using UV light, for example, as discussed above. Following the curing cycle, the gear rack(s) 10 could be removed and assembled to a drive mechanism and/or a slide-out room. In other embodiments, the curing machine could be configured to receive more or fewer than two gear racks 10 at a time.

In an embodiment, a travel stop 16 may be formed at respective first ends of first and second gear racks 10, for example, as described above. The gear racks 10 with travel stops 16 formed therein may be joined to a drive mechanism including first and second pinion gears engaged with and configured to selectively drive the first and second gear racks to form a drive assembly. For example, the second ends of the gear racks 10 maybe engaged, respectively, with the first and second pinion gears, and the pinion gears may be operated to draw the gear racks into the drive mechanism. One such drive mechanism is disclosed in U.S. Pat. No. 9,139,291, the disclosure of which is incorporated herein in its entirety.

In other embodiments, the drive mechanism and drive assembly may include more or fewer than two gear racks and/or pinion gears.

The foregoing drive assembly may be installed on a wall (which may be a side wall, a top wall or a bottom wall) of a slide out room, for example, as described in U.S. Pat. No. 9,139,291, with the first ends of the gear racks 10 and the travel stops 16 formed therein proximate the inner end of the slide out room. An outer flange may be installed at the outer end of the slide out room, the outer flange extending laterally (or peripherally) outwardly from the outer end of the slide out room. The slide out room may be installed into an RV or other structure, for example, as described in the foregoing U.S. Pat. No. 9,139,291.

With the drive assembly and the slide out room so installed to the wall and the RV, engagement of the outer flange with the outer surface of the wall precludes overdriving the gear racks 10 and, therefore, the slide out room into the interior space of the recreational vehicle or other structure. Also, the travel stops 16 formed into the respective first ends of the gear racks 10 preclude overdriving the gear racks 10 and, therefore, the slide out room out of the recreational vehicle or other structure.

### Experiment 1

An experiment was conducted using an IN-WALL® slide-out operating system available from Lippert Components, Inc. The IN-WALL® system is configured to operate a slide-out room of a recreational vehicle (RV), trailer, or the like. The IN-WALL® system is an embodiment of the operating mechanism disclosed in U.S. Pat. No. 9,193,291, the disclosure of which is incorporated herein by reference.

The IN-WALL® system includes, among other features, a first pair of gear racks attachable to a first side wall of a slide-out room of a recreational vehicle or trailer, and a second pair of gear racks attachable to a second side wall of the slide-out room. One of each of the pairs of gear racks is attachable to an upper portion of the respective side wall, and the other of each of the pairs of gear racks is attachable to a lower portion of the respective side wall.

A first drive unit is attachable to a first jamb of an opening in the side wall of the recreational vehicle or trailer receiving the slide-out room. The first drive unit includes an upper pinion gear engaged with the upper gear rack attachable to the first side wall of the slide out room, and a lower pinion gear rack engaged with the lower gear rack attachable to the first side wall of the slide out room. The upper and lower pinion gears are keyed to a torque shaft driven by an electric motor. A similar, second drive unit is similarly attachable to a second jamb of the opening and similarly engaged with the gear racks attachable to the second side wall of the slide-out room. Operation of the motors in a first direction causes the slide-out room to extend from the vehicle, and operation of the motors in a second direction causes the slide-out room to retract into the vehicle.

A travel stop was installed at respective first or inner ends of the foregoing gear racks as follows.

The valley inboard of the last fully machined tooth at respective first ends of each one of the gear racks was cleaned by wiping it with isopropyl alcohol.

A bead of LOCTITE® 3972 UV curable adhesive was applied to the foregoing valleys. Each bead of adhesive completely filled the respective valley, with a 1/16″ dome of adhesive extending above the valley and the face of the gear rack. The beads of LOCTITE® 3972 UV curable adhesive were cured by applying 405 μm ultraviolet light for 10 s at a distance of 1 cm from the bead using a LOCTITE® model 7700 hand held LED light source.

The gear racks including the cured adhesive travel stops were then assembled to the corresponding drive units and engaged with the corresponding pinion gears of the IN-WALL® system.

The gear racks were installed to opposed side walls of a slide-out room in a conventional manner The slide-out room was installed into a test stand replicating a side wall of a vehicle defining an opening therein, and the drive units were attached to the test stand, thus replicating a typical installation of a slide-out room and IN-WALL® system in a vehicle.

The IN-WALL® system was operated in a conventional manner, using the standard control system, to extend the racks until the drive motors stalled out and to retract the racks until the drive motors stalled out. This process was repeated for four cycles. In the course of the four cycles, the pinion gears engaged and indented the cured adhesive applied to the valleys at the first ends of the corresponding gear racks. The gear racks did not disengage from the drive units, and no further degradation of the cured adhesive bead or the drive system was observed, other than the indentation described above.

The IN-WALL® system was then operated in a conventional manner, using the standard control system, to extend and retract the racks without the pinion gears engaging the cured adhesive. This process was repeated for 2000 cycles. The racks did not disengage from the drive system, and no further degradation of the cured adhesive bead or the drive system was observed.

### Experiment 2

A second experiment was conducted using the same protocol as Experiment 1, but using LOCTITE® 3979 UV curable adhesive instead of the curable adhesive used in Experiment 1. The second experiment yielded substantially the same results as Experiment 1.

Certain illustrative embodiments and experiments are shown and described herein. Features disclosed in connection with a given embodiment may be incorporated into other embodiments to the greatest extent possible, and the embodiments may be otherwise modified without departure from the scope of the invention as set forth in the appended claims.

1. A method of forming a travel stop for a gear rack, the travel stop capable of arresting motion of the gear rack when the travel stop is engaged by a drive gear engaged with and driving the gear rack, the method comprising the steps of:
providing a gear rack comprising a plurality of teeth, each one of the plurality teeth defining a corresponding ridge, and adjacent ones of the plurality of teeth defining corresponding valleys therebetween;
applying an uncured curable adhesive to the gear rack within one of the valleys; and
curing the curable adhesive.

2. The method of claim 1 wherein the step of applying takes place before the step of curing.

3. The method of claim 2 further comprising the step of cleaning the one of the valleys prior to performing the step of applying.

4. The method of claim 1 wherein the curable adhesive is curable by exposure to ultraviolet light and wherein the step of curing comprises curing the curable adhesive using ultraviolet light.

5. The method of claim 1 wherein the step of applying comprises applying the curable adhesive so that it extends above the respective ridges of the adjacent ones of the plurality of teeth.

6. The method of claim 1 wherein the step of applying comprises applying the curable adhesive so that it forms a dome extending above the respective ridges of the adjacent ones of the plurality of teeth.

7. The method of claim 1 wherein the step of applying comprises applying the curable adhesive in a bead completely filling the valley.

8. The method of claim 7 wherein the step of applying comprises applying the curable adhesive so that it extends above the respective ridges of the adjacent ones of the plurality of teeth.

9. A gear rack defining a plurality of teeth and a plurality of valleys between adjacent ones of the plurality of teeth, the gear rack comprising a travel stop occupying at least one of the valleys, the travel stop comprising a cured, curable adhesive.

10. The gear rack of claim 9 wherein the cured, curable adhesive is self-bonded to the gear rack.

11. The gear rack of claim 9 wherein the travel stop is capable of arresting motion of the gear rack when the travel stop is engaged by a drive gear engaged with and driving the gear rack.

12. A method of installing a slide out room into a structure, the method comprising the step of:
providing a gear rack comprising a plurality of teeth, each one of the plurality teeth defining a corresponding ridge, and adjacent ones of the plurality of teeth defining corresponding valleys therebetween;
applying an uncured curable adhesive to the gear rack within one of the valleys proximate a first end of the gear rack;
curing the curable adhesive;
engaging the gear rack with a drive mechanism comprising a pinion gear, thereby forming a drive assembly;
installing the drive assembly to a wall of the slide out room with the first end of the gear rack proximate an inner end of the slide out room; and
installing the drive assembly to a structure configured to receive the slide out room with the inner end of the slide out room received within the structure.

13. The method of claim 12 further comprising the step of installing an outer flange to the slide out room proximate the outer end of the slide out room prior to the step of installing the drive assembly to a structure.

14. The method of claim 12 wherein the step of applying takes place before the step of curing.

15. The method of claim 14 further comprising the step of cleaning the one of the valleys prior to performing the step of applying.

16. The method of claim 12 wherein the curable adhesive is curable by exposure to ultraviolet light and wherein the step of curing comprises curing the curable adhesive using ultraviolet light.

17. The method of claim 12 wherein the step of applying comprises applying the curable adhesive so that it extends above the respective ridges of the adjacent ones of the plurality of teeth.

18. The method of claim 12 wherein the step of applying comprises applying the curable adhesive so that it forms a dome extending above the respective ridges of the adjacent ones of the plurality of teeth.

19. The method of claim 12 wherein the travel stop is capable of arresting motion of the gear rack when the travel stop is engaged by the drive gear when the drive gear is driving the gear rack.

20. The method of claim 12, the drive mechanism further comprising a motor operably connected to the pinion gear, wherein the travel stop is capable of arresting motion of the gear rack when the travel stop is engaged by the drive gear when the drive gear is driven by the motor and thereby is driving the gear rack.
